(19) United States
(12) Patent Application Publication
(10) Pub. No.: US 2024/0039121 A1
(43) Pub. Date: Feb. 1, 2024

(54) BATTERY

(71) Applicant: Prime Planet Energy & Solutions, Inc., Tokyo (JP)

(72) Inventors: Taisuke ISEDA, Kobe-shi (JP); Akira NISHIDA, Himeji-shi (JP)

(21) Appl. No.: 18/358,939

(22) Filed: Jul. 26, 2023

(30) Foreign Application Priority Data
Jul. 28, 2022 (JP) 2022-120871

(51) Int. Cl. H01M 50/46; H01M 10/0587; H01M 50/449

(52) U.S. Cl. CPC H01M 50/461; H01M 10/0587; H01M 50/449

(57) ABSTRACT

A battery disclosed here includes a positive electrode including a positive electrode active material layer, a negative electrode including a negative electrode active material layer, a separator, and a wound electrode body in which the positive electrode and the negative electrode are wound with the separator interposed therebetween. The separator includes an adhesive layer on at least one surface of the separator. The adhesive layer has a different weight per area in a longitudinal direction of the separator.

### CROSS REFERENCE TO RELATED APPLICATIONS

The present application claims priority from Japanese Patent Application No. 2022-120871 filed on Jul. 28, 2022, which is incorporated by reference herein in its entirety.

### BACKGROUND OF THE DISCLOSURE

### 1. Field

The present disclosure relates to a battery.

### 2. Background

A known battery includes a wound electrode body in which a strip-shaped positive electrode including a positive electrode active material layer and a strip-shaped negative electrode including a negative electrode active material layer are wound in a longitudinal direction with a strip-shaped separator interposed therebetween. JP5328034 A, for example, discloses a wound electrode body in which an adhesive is applied onto the entire surface of a separator so that the separator is united with at least one of a positive electrode and a negative electrode.

### SUMMARY

A result of study by the inventors of the present disclosure, however, shows that when an adhesive is applied onto the entire surface of a separator, a wound electrode body is not easily impregnated with an electrolyte, which might cause the possibility of a decrease in ability of impregnating the wound electrode body with an electrolyte (hereinafter referred to as an impregnation ability). On the other hand, when no adhesive is applied to the separator, formability of the wound electrode body might decrease. It is therefore an object of the present disclosure to provide a battery having both suitable formability of the wound electrode body and suitable the impregnation with the electrolyte.

A battery disclosed here includes: a wound electrode body in which a strip-shaped positive electrode including a positive electrode active material layer and a strip-shaped negative electrode including a negative electrode active material layer are wound with a strip-shaped separator interposed therebetween. The separator includes an adhesive layer disposed on at least a surface of the separator. A weight per area of the adhesive layer varies in a longitudinal direction of the separator.

The adhesive layer is provided in a predetermined weight per area in the separator so that a shape of the wound electrode body can be thereby sufficiently kept, thus enhancing formability of the wound electrode body. In the configuration described above, excessive formation of the adhesive layer is suppressed in the separator, and sufficient impregnation ability of the wound electrode body is obtained. Thus, the battery achieves both suitable formability of the wound electrode body and suitable impregnation with the electrolyte.

The “the adhesive layer weight per area (g/m²)” herein is a mass (g) of the adhesive layer to an area (m²) where the adhesive layer is formed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a battery according to one preferred embodiment.

FIG. 2 is a schematic longitudinal cross-sectional view taken along line II-II in FIG. 1.

FIG. 3 is a schematic transverse cross-sectional view taken along line III-III in FIG. 1.

FIG. 4 is a schematic longitudinal cross-sectional view taken along line IV-IV in FIG. 2.

FIG. 5 is a schematic view illustrating a configuration of a wound electrode body according to a first preferred embodiment.

FIG. 6 schematically illustrates a configuration of a separator.

FIG. 7 is a plan view schematically illustrating an example of a surface of the separator.

FIG. 8 schematically illustrates an example of formation positions of first formation regions and second formation regions in the wound electrode body.

FIG. 9 is a plan view schematically illustrating another example of the surface of the separator.

FIG. 10 is a plan view schematically illustrating another example of the surface of the separator.

FIG. 11 schematically illustrates another example of the formation positions of the first formation regions and the second formation regions in the wound electrode body.

FIG. 12 is a plan view schematically illustrating another example of the surface of the separator.

FIG. 13 is an enlarged view schematically illustrating interfaces between the separator and positive and negative electrodes.

FIG. 14 illustrates a battery according to a second preferred embodiment and corresponds to FIG. 2.

FIG. 15 schematically illustrates formation positions of first formation regions and second formation regions in a wound electrode body according to the second preferred embodiment and corresponds to FIG. 8.

FIG. 16 illustrates a separator according to a first variation and corresponds to FIG. 7.

FIG. 17 illustrates a separator according to a second variation and corresponds to FIG. 7.

FIG. 18 illustrates a separator according to a third variation and corresponds to FIG. 7.

FIG. 19 is an illustration for describing formation angles of a second formation region according to a third variation.

FIG. 20 illustrates a separator according to a fourth variation and corresponds to FIG. 7.

FIG. 21 is an illustration for describing a formation angle of a second formation region according to the fourth variation.

### DETAILED DESCRIPTION

A preferred embodiment of the technique disclosed here will be described hereinafter with reference to the drawings. Matters not specifically mentioned herein but required for carrying out the technique disclosed here (e.g., a general configuration and a general fabrication process of a battery that do not characterize the technique disclosed here) can be understood as design matter of those skilled in the art based on related art in the field. The technique disclosed here can be carried out based on the contents disclosed herein and common general knowledge in the field. The expression “A to B” indicating a range herein includes “more than A” and “less than B” as well as “A or more and B or less.”

A “battery” herein is a general term for a power storage device capable of extracting electrical energy therefrom, and is a concept including primary batteries and secondary batteries. A “secondary battery” herein is a general term for a power storage device capable of being repeatedly charged and discharged by movement of charge carriers between a positive electrode and a negative electrode through an electrolyte, and is a concept including so-called storage batteries (chemical batteries) such as a lithium ion secondary battery and a nickel-metal hydride battery, and capacitors (physical batteries) such as an electric double layer capacitor.

### First Embodiment

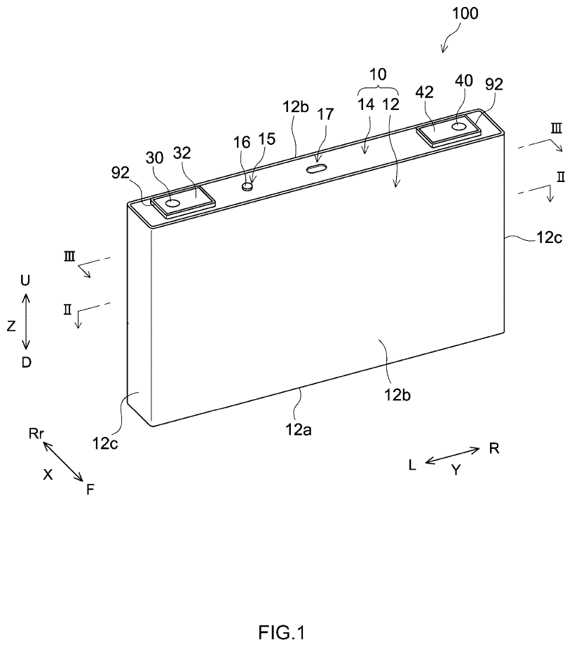

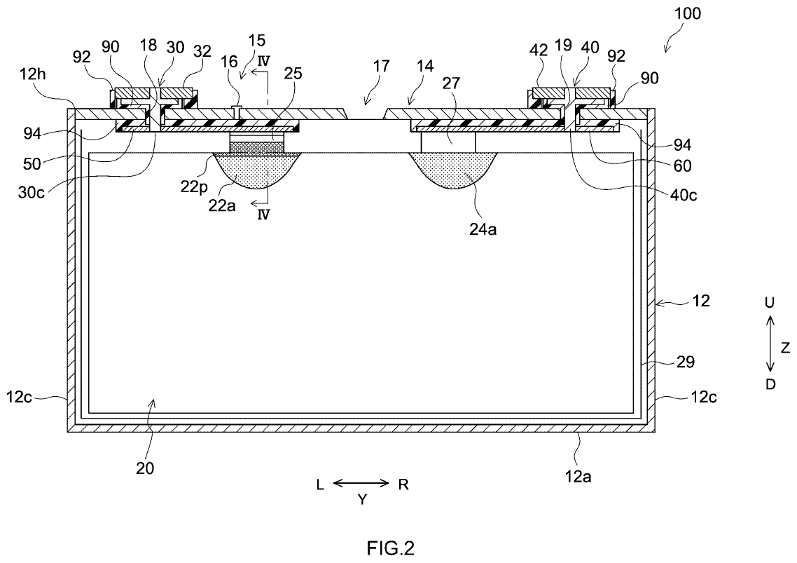

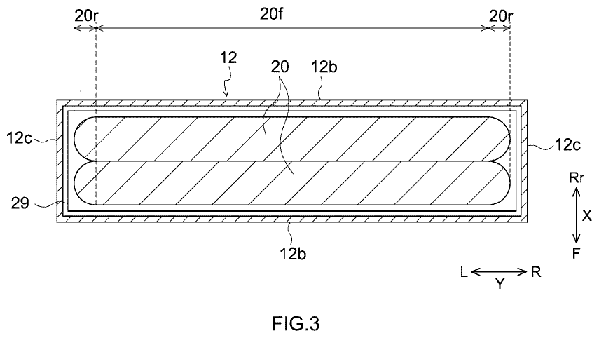

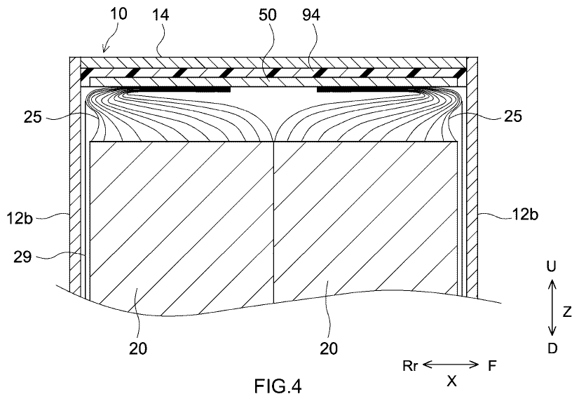

FIG. 1 is a perspective view of a battery 100. The battery 100 is preferably a secondary battery and more preferably a lithium ion secondary battery. FIG. 2 is a schematic longitudinal cross-sectional view taken along line II-II in FIG. 1. FIG. 3 is a schematic transverse cross-sectional view taken along line III-III in FIG. 1. FIG. 4 is a schematic longitudinal cross-sectional view taken along line IV-IV in FIG. 2. In the following description, characters L, R, F, Rr, U, and D in the drawings represent left, right, front, rear, up, and down, respectively. Character X in the drawings represents a “short-side direction of a battery,” character Y represents a “long-side direction of the battery,” and character Z represents a “top-bottom direction of the battery.” It should be noted that these directions are defined merely for convenience of description, and do not limit the state of installation of the battery 100.

As illustrated in FIGS. 1 and 2, the battery 100 includes a battery case 10, a plurality of wound electrode bodies 20, a positive electrode terminal 30, a negative electrode terminal 40, a positive electrode current collector 50, and a negative electrode current collector 60. Although not shown, the battery 100 further includes an electrolyte in this preferred embodiment. The battery 100 is a nonaqueous electrolyte secondary battery. A specific configuration of the battery 100 will be hereinafter described.

The battery case 10 is a casing housing the wound electrode bodies 20. In this preferred embodiment, the battery case 10 has a rectangular parallelepiped (square) with a bottom. A material for the battery case 10 may be a material conventionally used and is not particularly limited. The battery case 10 is preferably made of a metal, and more preferably made of a metal such as aluminium, an aluminium alloy, iron, or an iron alloy. As illustrated in FIG. 2, the battery case 10 includes a package 12 having an opening 12h, and a sealing plate (lid) 14 covering the opening 12h. Each of the package 12 and the sealing plate 14 has a size depending on the number (one or plural, plural in this preferred embodiment) and the size, for example, of wound electrode bodies 20 housed therein.

As illustrated in FIG. 1, the package 12 includes a bottom wall 12a, a pair of long side walls 12b extending from the bottom wall 12a, and a pair of short side walls 12c extending from the bottom wall 12a. The bottom wall 12a is substantially rectangular. The bottom wall 12a is opposed to the opening 12h (see FIG. 2). The sealing plate 14 is attached to the package 12 to cover the opening 12h of the package 12. The sealing plate 14 is opposed to the bottom wall 12a of the package 12. The sealing plate 14 is substantially rectangular in plan view. In the battery case 10, the sealing plate 14 is joined (e.g., welded) to a periphery of the opening 12h of the package 12 to be thereby integrated with the package 12. The battery case 10 is hermetically (airtightly) sealed.

As illustrated in FIG. 2, the sealing plate 14 includes an injection hole 15, a gas release valve 17, and two terminal lead holes 18 and 19. The injection hole 15 is a through hole for injecting an electrolyte into the battery case 10 after attaching the sealing plate 14 to the package 12. The injection hole 15 is sealed by a sealing member 16 after injection of the electrolyte. The gas release valve 17 is a thin portion configured such that when a pressure in the battery case 10 increases to a predetermined value or more, the gas release valve 17 is broken and releases a gas in the battery case 10 to the outside.

The battery case 10 can house the electrolyte together with the electrode bodies 20 as described above. As the electrolyte, a known electrolyte conventionally used for a battery can be used without any particular limitation. As an example, a nonaqueous electrolyte in which a supporting electrolyte is dissolved in a nonaqueous solvent can be used. Examples of the nonaqueous solvent include carbonate-based solvents such as ethylene carbonate, dimethyl carbonate, and ethyl methyl carbonate. Examples of the supporting electrolyte include fluorine-containing lithium salts such as LiPF₆.

The positive electrode terminal 30 is attached to one end (left end in FIGS. 1 and 2) of the sealing plate 14 in the long-side direction Y. The negative electrode terminal 40 is attached to the other end (right end in FIGS. 1 and 2) of the sealing plate 14 in the long-side direction Y. The positive electrode terminal 30 and the negative electrode terminal 40 are inserted in the terminal lead holes 18 and 19 and exposed at the outer surface of the sealing plate 14. The positive electrode terminal 30 is electrically connected to a plate-shaped positive electrode external conductive member 32 at the outside of the battery case 10. The negative electrode terminal 40 is electrically connected to a plate-shaped negative electrode external conductive member 42 at the outside of the battery case 10. The positive electrode external conductive member 32 and the negative electrode external conductive member 42 are connected to another secondary battery and external equipment through an external connection member such as a bus bar. Each of the positive electrode external conductive member 32 and the negative electrode external conductive member 42 is preferably made of a highly conductive metal, such as aluminium, an aluminium alloy, copper, or a copper alloy. It should be noted that the positive electrode external conductive member 32 and the negative electrode external conductive member 42 are not necessary components, and may be omitted in other preferred embodiments.

As illustrated in FIGS. 3 and 4, in the battery 100 of this preferred embodiment, the plurality of (two) wound electrode bodies 20 are housed in the battery case 10. Each of the wound electrode bodies 20 includes a positive electrode tab group 25 and a negative electrode tab group 27 (see FIG. 2), and a specific configuration of the wound electrode bodies 20 will be described later. These electrode tab groups (the positive electrode tab group 25 and the negative electrode tab group 27) are connected to the electrode current collectors (the positive electrode current collector 50 and the negative electrode current collector 60) while being bent.

The positive electrode current collector 50 electrically connects the positive electrode tab group 25 of the wound electrode bodies 20 to the positive electrode terminal 30. As illustrated in FIG. 2, the positive electrode current collector 50 is a plate-shaped conductive member extending in the long-side direction Y along the inner surface of the sealing plate 14. One side (the left side in FIG. 2) of the positive electrode current collector 50 is electrically connected to a lower end 30c of the positive electrode terminal 30. The other side (right side in FIG. 2) of the positive electrode current collector 50 is electrically connected to the positive electrode tab group 25. Each of the positive electrode terminal 30 and the positive electrode current collector 50 is preferably made of a highly conductive metal. Each of the positive electrode terminal 30 and the positive electrode current collector 50 can be aluminium or an aluminium alloy, for example.

The negative electrode current collector 60 electrically connects the negative electrode tab group 27 of the wound electrode bodies 20 to the negative electrode terminal 40. As illustrated in FIG. 2, the negative electrode current collector 60 is a plate-shaped conductive member extending in the long-side direction Y along the inner surface of the sealing plate 14. One side (right side in FIG. 2) of the negative electrode current collector 60 is electrically connected to a lower end 40c of the negative electrode terminal 40. The other side (left side in FIG. 2) of the negative electrode current collector 60 is electrically connected to the negative electrode tab group 27. Each of the negative electrode terminal 40 and the negative electrode current collector 60 is preferably made of a highly conductive metal. Each of the negative electrode terminal 40 and the negative electrode current collector 60 can be copper or a copper alloy, for example.

The battery 100 includes various insulating members in order to prevent continuity between the wound electrode bodies 20 and the battery case 10. For example, as illustrated in FIG. 1, the positive electrode external conductive member 32 and the negative electrode external conductive member 42 are insulated from the sealing plate 14 by an external insulating member 92. As illustrated in FIG. 2, a gasket 90 is attached to each of the terminal lead holes 18 and 19 of the sealing plate 14. Accordingly, continuity between the positive electrode terminal 30 (or the negative electrode terminal 40) inserted in the terminal lead hole 18 or 19 and the sealing plate 14 can be prevented. An internal insulating member 94 is disposed between the inner surface of the sealing plate 14 and each of the positive electrode current collector 50 and the negative electrode current collector 60. Accordingly, continuity between the sealing plate 14 and each of the positive electrode current collector 50 and the negative electrode current collector 60 can be reduced. As also described in a second preferred embodiment below, the internal insulating member 94 may include a projection projecting toward the wound electrode bodies 20.

The wound electrode bodies 20 are disposed in the package 12 while being covered with an electrode body holder 29 (see FIG. 2) of an insulating resin sheet. This can prevent direct contact between the wound electrode bodies 20 and the package 12. Materials for the insulating members described above are not particularly limited as long as these insulating members have predetermined insulating properties. Examples of such materials include synthetic resin materials exemplified by polyolefin-based resins such as polypropylene (PP) and polyethylene (PE), and fluorine-based resins such as perfluoroalkoxy alkane and polytetrafluoroethylene (PTFE).

The package 12 houses two wound electrode bodies 20 in this preferred embodiment. The number of wound electrode bodies disposed in one package 12 is not particularly limited, and may be three or more (plural) or may be one. As illustrated in FIG. 3, the wound electrode bodies 20 include a pair of curved portions 20r opposed to the short side walls 12c of the package 12, and a flat portion 20f coupling the pair of curved portions 20r and opposed to long side walls 12b of the package 12.

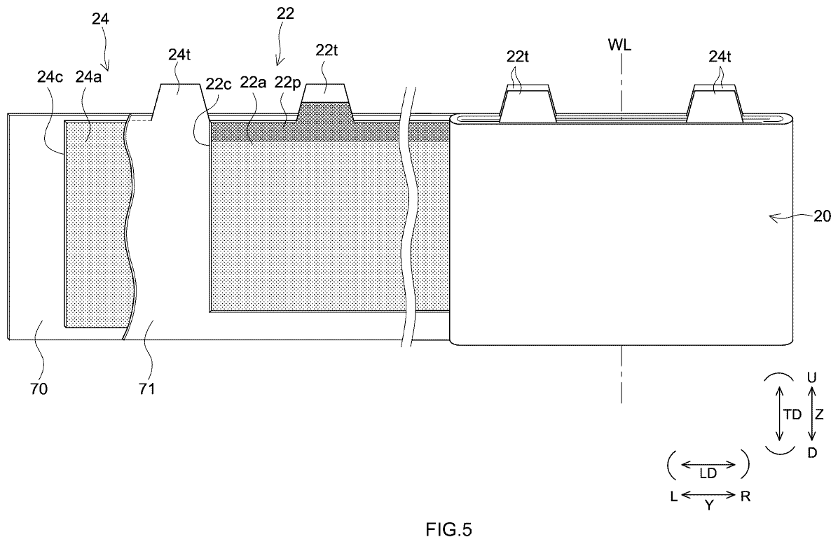

FIG. 5 is a schematic view illustrating a configuration of the wound electrode bodies 20. As illustrated in FIG. 5, in each of the wound electrode bodies 20, a strip-shaped positive electrode 22 and a strip-shaped negative electrode 24 are stacked and insulated with two strip-shaped separators 70 and 71 interposed therebetween, and wound around a winding axis WL in the longitudinal direction. Character LD in FIG. 5 and other drawings indicates the longitudinal direction (i.e., conveyance direction) of the wound electrode bodies 20 and the separator 70 fabricated in strip shapes. The longitudinal direction LD coincides with the long-side direction Y of the battery 100 described above. Caracter TD indicates a direction orthogonal to the longitudinal direction LD and a width direction of the wound electrode bodies 20 and the separator 70. The width direction TD coincides with the top-bottom direction Z of the battery 100 described above. In the following description, the left side in the longitudinal direction LD in FIG. 5 and other drawings will be referred to as a winding start side of the wound electrode bodies 20 and the left side will be referred to as a winding end side of the wound electrode bodies 20.

The wound electrode bodies 20 are disposed in the package 12 such that the winding axis WL (see FIG. 5) is parallel to the top-bottom direction Z of the package 12. In other words, the wound electrode bodies 20 are disposed in the package 12 such that the winding axis WL is parallel to the short side walls 12c and orthogonal to the bottom wall 12a. An end surface (i.e., an end surface on which the positive electrode 22 and the negative electrode 24 are stacked, an end surface in the width direction TD in FIG. 5) of the wound electrode bodies 20 is opposed to the bottom wall 12a and the sealing plate 14.

As illustrated in FIG. 5, the positive electrode 22 is a strip-shaped member. The positive electrode 22 includes a strip-shaped positive electrode current collector 22c, a positive electrode active material layer 22a, and a positive electrode protective layer 22p. The positive electrode active material layer 22a and the positive electrode protective layer 22p are fixed to at least a surface of the positive electrode current collector 22c. It should be noted that the positive electrode protective layer 22p is not necessary and may be omitted in other preferred embodiments. As members constituting the positive electrode 22, known materials that can be used for a general battery (e.g., lithium ion secondary battery) can be used without any particular limitation. For example, the positive electrode current collector 22c is preferably made of a conductive metal such as aluminium, an aluminium alloy, nickel, or stainless steel. The positive electrode current collector 22c is metal foil in this preferred embodiment, and specifically aluminium foil.

As illustrated in FIG. 5, in the positive electrode 22, a plurality of positive electrode tabs 22t project outward (upward in FIG. 5) from one side of the wound electrode bodies 20 in the width direction TD. The plurality of positive electrode tabs 22t are disposed with predetermined intervals (intermittently) along the longitudinal direction LD. The positive electrode tabs 22t are connected to the positive electrode 22. The positive electrode tabs 22t are a part of the positive electrode current collector 22c in this preferred embodiment, and is made of metal foil (specifically aluminium foil). The positive electrode tabs 22t are regions where no positive electrode active material layer 22a is formed and the positive electrode current collector 22c is exposed. The positive electrode active material layer 22a and/or the positive electrode protective layer 22p may be provided in part of the positive electrode tabs 22t, and the positive electrode tabs 22t may be members different from the positive electrode current collector 22c. Each of the plurality of positive electrode tabs 22t is a trapezoid. The shape of each positive electrode tab 22t is not limited to this example. The size of the plurality of positive electrode tabs 22t is not specifically limited. The shape and size of the positive electrode tabs 22t can be appropriately adjusted depending on, for example, the position where the positive electrode tabs 22t are formed, in consideration of a state where the positive electrode tabs 22t are connected to the positive electrode current collector 50, for example. The plurality of positive electrode tabs 22t are stacked at one end (upper end in FIG. 5) of the positive electrode 22 in the width direction TD, and constitute the positive electrode tab group 25 (see FIG. 2).

As illustrated in FIG. 5, the positive electrode active material layer 22a has a strip shape along the longitudinal direction LD of the strip-shaped positive electrode current collector 22c. The positive electrode active material layer 22a includes a positive electrode active material that can reversibly absorb and desorb charge carriers (e.g., a lithium transition metal composite oxide such as lithium-nickel-cobalt-manganese composite oxide). Supposing the entire solid content of the positive electrode active material layer 22a is 100 mass %, the positive electrode active material may be approximately 80 mass % or more, typically 90 mass % or more, and 95 mass % or more, for example. The positive electrode active material layer 22a may include components other than the positive electrode active material, such as a conductive material, a binder, and additives. Examples of the conductive material include a carbon material such as acetylene black (AB). Examples of the binder include fluorine-based resins such as polyvinylidene fluoride (PVdF).

The positive electrode protective layer 22p has a lower electrical conductivity than that of the positive electrode active material layer 22a. As illustrated in FIG. 5, the positive electrode protective layer 22p has a strip shape along the longitudinal direction LD of the strip-shaped positive electrode current collector 22c. As illustrated in FIG. 5, the positive electrode protective layer 22p is disposed at the boundary between the positive electrode current collector 22c and the positive electrode active material layer 22a in the width direction TD. In this preferred embodiment, the positive electrode protective layer 22p is disposed at an end (upper end in FIG. 5) of the positive electrode current collector 22c in the width direction TD. It should be noted that the positive electrode protective layer 22p may be disposed at each end in the width direction TD. The presence of the positive electrode protective layer 22p can prevent short circuit of the battery 100 caused by direct contact between the positive electrode current collector 22c and the negative electrode active material layer 24a when the separators 70 and 71 are broken.

The positive electrode protective layer 22p includes an insulating inorganic filler, such as ceramic particles of, for example, alumina. Supposing the entire solid content of the positive electrode protective layer 22p is 100 mass %, the inorganic filler may be approximately 50 mass % or more, typically 70 mass % or more, and, for example, 80 mass % or more. The positive electrode protective layer 22p may include components other than the inorganic filler, such as a conductive material, a binder, and additives. The conductive material and the binder may be the same as those that can be included in the positive electrode active material layer 22a as exemplified above.

As illustrated in FIG. 5, the negative electrode 24 is a strip-shaped member. The negative electrode 24 includes a strip-shaped negative electrode current collector 24c and a negative electrode active material layer 24a fixed onto at least a surface of the negative electrode current collector 24c. As members constituting the negative electrode 24, known materials that can be used for a general battery (e.g., lithium ion secondary battery) can be used without any particular limitation. For example, the negative electrode current collector 24c is preferably made of a conductive metal such as copper, a copper alloy, nickel, or stainless steel. The negative electrode current collector 24c is metal foil in this preferred embodiment, and specifically copper foil.

As illustrated in FIG. 5, in the negative electrode 24, a plurality of negative electrode tabs 24t project outward (upward in FIG. 5) from one side of the wound electrode bodies 20 in the width direction TD. The plurality of negative electrode tabs 24t are disposed with predetermined intervals (intermittently) along the longitudinal direction LD. The negative electrode tabs 24t are connected to the negative electrode 24. The negative electrode tabs 24t are a part of the negative electrode current collector 24c in this preferred embodiment, and is made of metal foil (specifically copper foil). The negative electrode tabs 24t are regions where the negative electrode active material layer 24a is not formed and the negative electrode current collector 24c is exposed. The negative electrode active material layer 24a may be provided in part of the negative electrode tabs 24t, and the negative electrode tabs 24t may be members different from the negative electrode current collector 24c. Each of the plurality of negative electrode tabs 24t is a trapezoid. The shape and size of the plurality of negative electrode tabs 24t can be appropriately adjusted in a manner similar to the positive electrode tabs 22t. The plurality of negative electrode tabs 24t are stacked at one end (upper end in FIG. 5) of the negative electrode 24 in the width direction TD, and constitute the negative electrode tab group 27 (see FIG. 2).

The negative electrode active material layer 24a is provided in a strip shape along the longitudinal direction LD of the strip-shaped negative electrode current collector 24c. The negative electrode active material layer 24a includes a negative electrode active material that can reversibly absorb and desorb charge carriers (e.g., a carbon material such as graphite). A width (length in the width direction TD, the same hereinafter) of the negative electrode active material layer 24a is preferably larger than a width of the positive electrode active material layer 22a. Supposing the entire solid content of the negative electrode active material layer 24a is 100 mass %, the negative electrode active material may be approximately 80 mass % or more, typically 90 mass % or more, and, for example, 95 mass % or more. The negative electrode active material layer 24a may include components other than the negative electrode active material, such as a conductive material, a binder, a disperser, and additives. Examples of the binder include rubbers such as styrene-butadiene rubber (SBR). Examples of the disperser include celluloses such as carboxymethyl cellulose (CMC).

The separators 70 and 71 are strip-shaped members. Each of the separators 70 and 71 is an insulating sheet having a plurality of minute through holes through which charge carriers can pass. A width of each of the separators 70 and 71 is larger than a width of the negative electrode active material layer 24a. The interposition of the separators 70 and 71 between the positive electrode 22 and the negative electrode 24 can prevent contact between the positive electrode 22 and the negative electrode 24 and allows charge carriers (e.g., lithium ions) to move between the positive electrode 22 and the negative electrode 24.

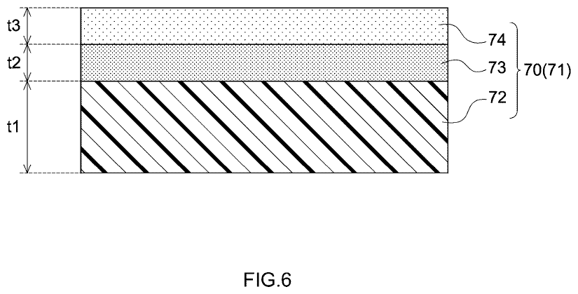

As illustrated in FIG. 6, an adhesive layer 74 is disposed on at least a surface of each of the separators 70 and 71. It is sufficient that the adhesive layer 74 is formed on at least one of the separators 70 and 71. Preferably, the adhesive layer 74 is formed on each of the separators 70 and 71. Each of the separators 70 and 71 includes a base material layer 72 typically made of a porous resin, and the adhesive layer 74 including an adhesive component. As illustrated in FIG. 6, in this preferred embodiment, a heat-resistant layer 73 is provided between the base material layer 72 and the adhesive layer 74.

As the base material layer 72, a known microporous film conventionally used for a separator of a battery can be used without any particular limitation. The base material layer 72 is preferably a porous sheet member. The base material layer 72 may have a single-layer structure or a multi-layer structure such as three-layer structure. The base material layer 72 is preferably made of a polyolefin resin. Accordingly, sufficient flexibility of the separator 70 is obtained, and fabrication (winding and press molding) of the wound electrode bodies 20 can be easily carried out. The polyolefin resin is preferably polyethylene (PE), polypropylene (PP), and a mixture thereof, and more preferably PE.

Although not particularly limited, a thickness t1 of the base material layer 72 is preferably 3 μm or more and 25 μm or less, more preferably 3 μm or more and 18 μm or less, and even more preferably 5 μm or more and 14 μm or less. An air permeability of the base material layer 72 is not particularly limited, and is preferably 30 sec/100 cc or more and 500 sec/100 cc or less, more preferably 30 sec/100 cc or more and 300 sec/100 cc or less, and even more preferably 50 sec/100 cc or more and 200 sec/100 cc or less. A porosity of the base material layer 72 is not particularly limited, and may be, for example, 20% or more and 70% or less, and 30% or more and 60% or less. The porosity of the base material layer 72 can be measured by mercury intrusion porosimetry.

The heat-resistant layer 73 is disposed on the base material layer 72. The heat-resistant layer 73 may be directly disposed on a surface of the base material layer 72, or may be disposed above the base material layer 72 with another layer interposed therebetween. It should be noted that the heat-resistant layer 73 is not necessary and may be omitted in other preferred embodiments. A weight per area of the heat-resistant layer 73 is uniform in the longitudinal direction LD and the width direction TD of the separator 70. Although not particularly limited, a thickness t2 of the heat-resistant layer 73 is preferably 0.3 μm or more and 6 μm or less, more preferably 0.5 μm or more and 6 μm or less, and even more preferably 1 μm or more and 4 μm or less. The heat-resistant layer 73 preferably includes an inorganic filler and a heat-resistant layer binder.

As the inorganic filler, known materials conventionally used for this type of application can be used without any particular limitation. The inorganic filler preferably includes insulating ceramic particles. Among these materials, in consideration of heat resistance and availability, inorganic acids such as alumina, zirconia, silica, and titania, metal hydroxides such as aluminium hydroxide, and clay minerals such as boehmite are preferable, and alumina and boehmite are more preferable. From the viewpoint of reducing heat contraction of the separator 70, a compound including aluminium is especially preferable. A proportion of the inorganic filler to the gross mass of the heat-resistant layer 73 is preferably 85 mass % or more, more preferably 90 mass % or more, and even more preferably 95 mass % or more. A content of inorganic particles is set to be greater than or equal to a predetermined content so that heat contraction of the base material layer 72 is thereby suppressed.

As the heat-resistant layer binder, known materials conventionally used for this type of application can be used without any particular limitation. Specific examples of the heat-resistant layer binder include an acrylic resin, a fluorine resin, an epoxy resin, a urethane resin, and an ethylene vinyl acetate resin. Among these resins, an acrylic resin is preferable.

As illustrated in FIG. 6, the adhesive layer 74 is formed on one surface of the separator 70 in this preferred embodiment. The adhesive layer 74 may be formed on each surface of the separator 70. It is sufficient that the adhesive layer 74 is provided on the outermost surface of the separators 70 and 71. The adhesive layer 74 may be provided directly on a surface of the base material layer 72, for example. Alternatively, the adhesive layer 74 may be provided on a surface of the heat-resistant layer 73 provided on a surface of the base material layer 72. Alternatively, the adhesive layer 74 may be provided above the base material layer 72 with another optional layer interposed therebetween. The adhesive layer 74 is preferably provided on a surface of the heat-resistant layer 73 disposed on one or each side of the base material layer 72.

A thickness t3 of the adhesive layer 74 can vary depending on a weight per area described later, and is preferably approximately 0.3 μm or more and 6 μm or less, more preferably 0.5 μm or more and 6 μm or less, and even more preferably 1 μm or more and 4 μm or less.

The adhesive layer 74 is bonded to an electrode (positive electrode and/or negative electrode) by, for example, heating or pressing (typically press molding). The adhesive layer 74 includes an adhesive layer binder. As the adhesive layer binder, known resin materials having a given viscosity to the positive electrode 22 can be used without any particular limitation. Specific examples of the heat-resistant layer binder include an acrylic resin, a fluorine resin, an epoxy resin, a urethane resin, and an ethylene vinyl acetate resin. Among these resins, because of high flexibility and high adhesion to the positive electrode 22, the fluorine resin and the acrylic resin are preferable. Examples of the fluorine resin include polyvinylidene fluoride (PVdF) and polytetrafluoroethylene (PTFE). The type of the adhesive layer binder may be the same as that of the heat-resistant layer binder or may be different from that of the heat-resistant layer binder. The proportion of the adhesive layer binder to the gross mass of the adhesive layer 74 is preferably 20 mass % or more, more preferably 50 mass % or more, and even more preferably 70 mass % or more. Accordingly, given adhesion to the positive electrode 22 is appropriately exhibited, and the separator 70 is easily deformed in press molding.

In addition to the adhesive layer binder, the adhesive layer 74 may include other materials (e.g., inorganic filler described as an example of a component of the heat-resistant layer 73). In a case where the adhesive layer 74 includes an inorganic filler, a proportion of the inorganic filler in the gross mass of the adhesive layer 74 is preferably 80 mass % or less, more preferably 50 mass % or less, and even more preferably 30 mass % or less.

The separator 70 of the battery 100 disclosed here includes the adhesive layer 74 in at least one surface, and the weight per area (g/m²) of the adhesive layer 74 varies in the longitudinal direction LD of the separator 70. In the wound electrode bodies 20, a phenomenon in which the flat portion 20f expands by an elastic action remaining in the curved portions 20r (hereinafter referred to as “spring back”) easily occurs. Since the weight per area of the adhesive layer 74 varies in the longitudinal direction LD of the separator 70, spring back as described above can be suitably reduced, for example. Accordingly, formability of the wound electrode bodies 20 is enhanced. On the other hand, in a case where the adhesive layer 74 is excessively provided on the surface of the separator 70, the electrolyte is absorbed in the adhesive layer 74 so that impregnation ability might decrease. Thus, from the viewpoint of electrolyte impregnation ability, it is preferable that the adhesive layer 74 is not excessively provided on the surface of the separator 70. From these perspectives, the position where the adhesive layer 74 is formed is appropriately adjusted in the longitudinal direction LD of the separators 70 and 71 so that a decrease in electrolyte impregnation ability is suppressed with spring back of the wound electrode bodies 20 appropriately reduced.

The following description will be directed to a configuration of the separator disclosed here using the separator 70 as an example, and the separator 71 also has a similar configuration. As described above, it is sufficient that at least one of the separators 70 and 71 has the following configuration.

The adhesive layer 74 is formed on at least a surface of the separator 70 of the battery 100 disclosed here. The inventors of the present disclosure found that in the case of bonding the positive electrode 22 and the separator 70, peeling is more likely to occur than in the case of bonding the negative electrode 24 and the separator 70. Thus, in view of this, the adhesive layer 74 is preferably formed on at least a surface to be in contact with the positive electrode 22. Accordingly, adhesion between the positive electrode 22 and the separator 70 of the wound electrode bodies 20 increases, and formability of the wound electrode bodies 20 is enhanced. On the other hand, adhesion between the negative electrode 24 and the separator 70 is relatively high, and even if the adhesive layer 74 is not formed on a side to be in contact with the negative electrode 24, sufficient formability of the wound electrode bodies 20 can be obtained. If the adhesive layer 74 is excessively formed as described above, impregnation ability might decrease. Thus, from these perspectives, the base material layer 72 of the separator 70 and the negative electrode 24 are preferably in contact with each other.

The adhesive layer 74 may be applied by solid coating or may be applied in a predetermined pattern. For example, the adhesive layer 74 may have a dot pattern, a striped pattern, a wave pattern, a band pattern (streak pattern), a broken line pattern, or a combination thereof, for example, in a plan view. The weight per area of the adhesive layer 74 described above can be controlled by changing a coating pattern of the adhesive layer 74, for example. As an example, it is preferable to apply overall coating (solid coating) to a region with a relatively large weight per area and apply partial coating to a region with a relatively small weight per area. Alternatively, the weight per area of the adhesive layer 74 can be controlled by changing the amount of coating even for the same coating pattern. As an example, it is preferable that the adhesive layer 74 is applied in a dot petter in both the region with a relatively large weight per area and the region with a relatively small weight per area and the amount of coating of the adhesive layer 74 in the region with a relatively small weight per area is smaller than that in the region with a relatively large weight per area.

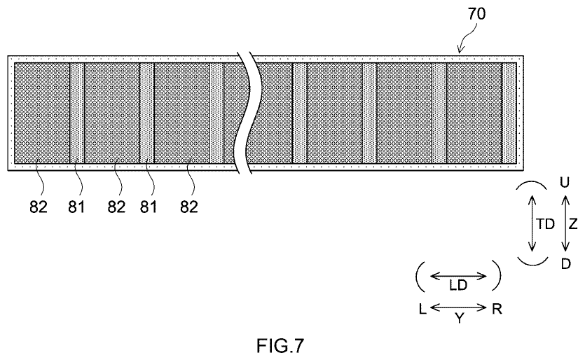

FIG. 7 is a plan view showing a surface of the separator 70 before the wound electrode bodies 20 are constructed. The separator 70 of the battery 100 disclosed here is formed such that the weight per area (g/m²) of the adhesive layer 74 varies in the longitudinal direction LD. The adhesive layer 74 is appropriately disposed at a position at which the adhesive layer 74 can suitably reduce spring back as described above. For example, as illustrated in FIG. 7, the separator 70 includes, in its surface, first formation regions 81 where the adhesive layer 74 is formed and second formation regions 82 where the adhesive layer 74 is formed, and the adhesive layer 74 in the first formation regions 81 has preferably smaller weight per area than the adhesive layer 74 in the second formation regions 82. The first formation regions 81 and the second formation regions 82 are preferably repeatedly formed in the longitudinal direction LD of the separator 70. With this configuration, the second formation regions 82 where the weight per area of the adhesive layer 74 are relatively large suitably reduces spring back and enhances formability of the wound electrode bodies 20. In the first formation regions 81 where the weight per area of the adhesive layer 74 is relatively small, the electrolyte easily permeates and impregnation ability increases. In addition, the amount of the adhesive layer 74 that can be a resistance component of the battery 100 is smaller than conventional so that battery performance of the battery 100 is enhanced.

It is sufficient that the weight per area A (g/m²) of the adhesive layer 74 in the first formation regions 81 is smaller than the weight per area B (g/m²) of the adhesive layer 74 in the second formation regions 82. For example, a ratio (A/B) of the weight per area A (g/m²) of the adhesive layer 74 in the first formation regions 81 to the weight per area B (g/m²) of the adhesive layer 74 in the second formation regions 82 is preferably 0.1 or more and 0.9 or less, may be 0.2 or more and 0.75 or less, and more preferably 0.3 or more and 0.5 or less. Although not particularly limited, the weight per area of the first formation regions 81 is preferably 0.005 to 1.0 g/m² and more preferably 0.02 to 0.04 g/m². And the second formation regions 82 is preferably 0.005 to 1.0 g/m² and more preferably 0.02 to 0.04 g/m².

The weight per area of the first formation regions 81 and the weight per area of the second formation regions 82 can be controlled by changing the coating pattern of the adhesive layer 74, for example. As an example, the first formation regions 81 may be formed by applying the adhesive layer 74 in a dot pattern with the second formation regions 82 formed by applying the adhesive layer 74 to the entire surface. Alternatively, the weight per area of the first formation regions 81 and the weight per area of the second formation regions 82 can be controlled by changing the amount of coating even for the same coating pattern. As an example, preferably, the adhesive layers 74 of both the first formation regions 81 and the second formation regions 82 is applied in dot patterns, and the coating amount of the adhesive layer 74 in the first formation regions 81 is smaller than that of the adhesive layer 74 in the second formation regions 82.

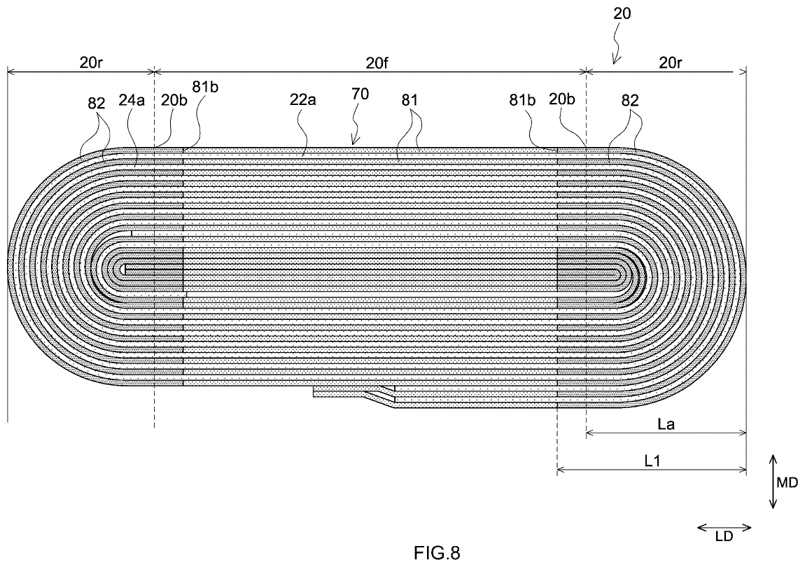

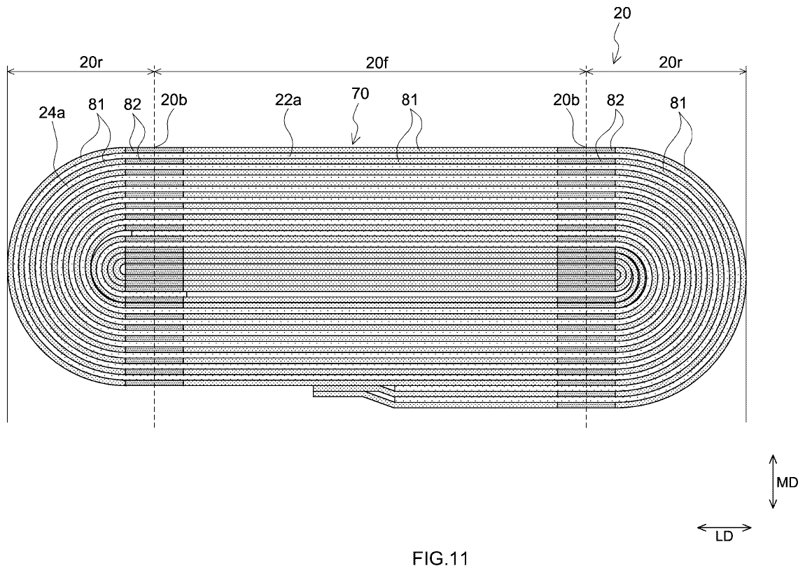

FIGS. 8 and 11 schematically illustrate examples of formation positions of the first formation regions 81 and the second formation regions 82 in the flat shape wound electrode bodies 20. Character MD in FIG. 8 and other drawings indicates a stacking direction of the wound electrode bodies 20, and coincides with the short-side direction X of the battery 100. The wound electrode bodies 20 are preferably flat shape, and preferably include the flat portion 20f and the curved portions 20r. The first formation regions 81 are preferably located in the flat portion 20f, and the second formation regions 82 are preferably located in the curved portions 20r. Accordingly, permeability of the electrolyte in the flat portion 20f is enhanced. Since the second formation regions 82 having a relatively large weight per area is located in the curved portions 20r, an inter-pole distance in the curved portions 20r is stabilized so that battery resistance can be thereby reduced.

A flat shape wound electrode body herein refers to a wound electrode body having a substantially oval shape in cross section and a so-called race track shape (see FIG. 3). The flat shape wound electrode bodies 20 can be formed by press-molding electrode bodies wound in a cylindrical shape into a flat shape.

The first formation regions 81 only need to be provided in at least a part of the flat portion 20f, and may be provided in the entire flat portion 20f. The second formation regions 82 only need to be provided in at least a part of the curved portions 20r, and may be provided in the entire curved portions 20r. A boundary 20b between the curved portions 20r and the flat portion 20f of the wound electrode bodies 20 does not need to coincide with a boundary 81b between the first formation regions 81 and the second formation regions 82. That is, as illustrated in FIG. 8, a part of the second formation regions 82 may be provided in the flat portion 20f. Alternatively, a part of the first formation regions 81 may be provided in the curved portions 20r.

In one preferred embodiment, as illustrated in FIG. 8, the second formation regions 82 are disposed at the boundary 20b between the curved portions 20r and the flat portion 20f, and in contact with a part of an end portion of the flat portion 20f. A length L1 of the second formation regions 82 in the longitudinal direction LD is preferably slightly larger than a length La of the curved portions 20r of the wound electrode bodies 20. For example, the length L1 of the second formation regions 82 is preferably larger than the length La of the curved portions 20r by 5% or more, and may be larger than the length La by 10% or more. On the other hand, the length L1 of the second formation regions 82 is preferably 150% or less of the length La of the curved portions 20r, and may be 125% or less of the length La.

On the other hand, from the viewpoint of suitably reducing spring back, it is preferable that the first formation regions 81 are disposed in the curved portions 20r and the second formation regions 82 are disposed in the flat portion 20f in the wound electrode bodies 20. As described above, spring back is a phenomenon in which the flat portion 20f expands by an elastic action remaining in the curved portions 20r of the wound electrode bodies 20. Thus, the second formation regions 82 having a relatively large weight per area of the adhesive layer 74 are disposed in the flat portion 20f so that spring back can be suitably reduced. In addition, the first formation regions 81 having a relatively small weight per area of the adhesive layer 74 are disposed in the curved portions 20r so that sufficient impregnation ability can be obtained in the curved portions 20r. Thus, with this configuration, both formability and impregnation ability of the wound electrode bodies 20 can be achieved.

In this case, the first formation regions 81 only need to be provided in at least a part of the curved portions 20r and may be provided in the entire curved portions 20r. The second formation regions 82 only need to be provided in at least a part of the flat portion 20f and may be provided in the entire flat portion 20f. As described above, the boundary 20b between the curved portions 20r and the flat portion 20f of the wound electrode bodies 20 does not need to coincide with the boundary 81b between the first formation regions 81 and the second formation regions 82. That is, a part of the first formation regions 81 may be provided in the flat portion 20f. Alternatively, a part of the second formation regions 82 may be provided in the curved portions 20r.

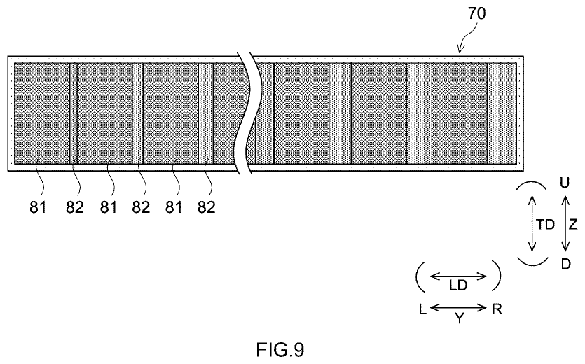

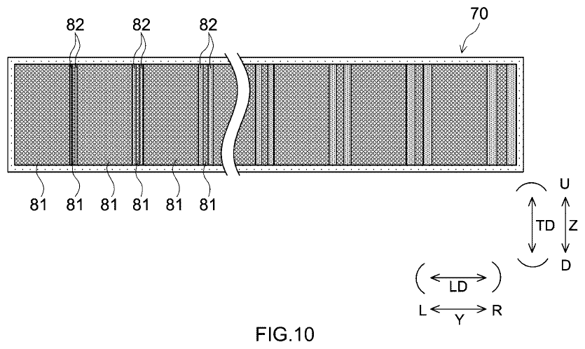

FIGS. 9 and 10 are plan views illustrating examples of the surface of the separator 70 before the wound electrode bodies 20 are constructed. In the separator 70, the length of each of the first formation regions 81 preferably varies in the longitudinal direction LD of the separator 70. Alternatively, in the separator 70, the length of each of the second formation regions 82 preferably varies in the longitudinal direction LD of the separator 70. The length of at least one of the first formation regions 81 or the second formation regions 82 preferably varies. The lengths of both the first formation regions 81 and the second formation regions 82 may vary. For example, as illustrated in FIG. 9, in the separator 70, the first formation regions 81 and the second formation regions 82 are repeatedly formed in the longitudinal direction LD, and the length of the second formation regions 82 is increased in conformity with the length of the curved portions 20r in constructing the wound electrode bodies 20. Although not shown, the separator 70 may be configured such that the first formation regions 81 and the second formation regions 82 are repeatedly formed in the longitudinal direction LD and the length of the first formation regions 81 is increased in conformity with the length of the curved portions 20r in constructing the wound electrode bodies 20. The length of the first formation regions 81 and/or the second formation regions 82 is adjusted in conformity with the length of the curved portions 20r in constructing the wound electrode bodies 20 as described above so that the first formation regions 81 and the second formation regions 82 can be disposed at desired positions of the wound electrode bodies 20. Although not particularly limited, from the viewpoint of formability of the wound electrode bodies 20, the length of the second formation regions 82 is increased in the longitudinal direction LD of the separator 70 such that the second formation regions 82 are located in the curved portions 20r of the wound electrode bodies 20.

As illustrated in FIG. 11, in one preferred embodiment, in the longitudinal direction LD of the separator 70, the first formation regions 81 and the second formation regions 82 are repeatedly formed, the first formation regions 81 are disposed in a part of the flat portion 20f and a part of the curved portions 20r, and the second formation regions 82 are disposed in a boundary vicinity region including the boundary 20b between the curved portions 20r and the flat portion 20f. The boundary vicinity region herein refers to a region including the boundary 20b between the curved portions 20r and the flat portion 20f and includes a part of the flat portion 20f and a part of the curved portions 20r. Stress is easily applied especially to the boundary 20b and the boundary vicinity region in constructing the wound electrode bodies 20. Thus, the second formation regions 82 having a relatively large weight per area are disposed in this region so that formability of the wound electrode bodies 20 can be more suitably enhanced. In addition, as compared to the case of providing the second formation regions 82 in the entire curved portions 20r, impregnation ability of the wound electrode bodies 20 can be further enhanced.

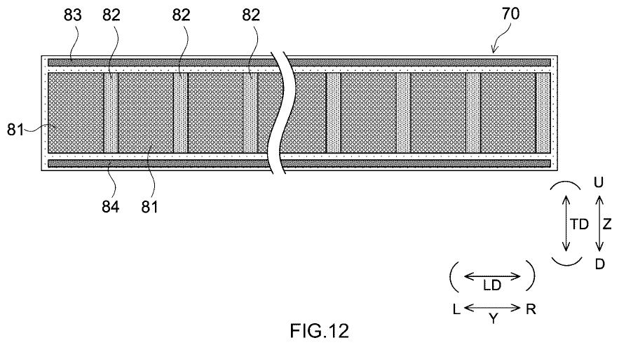

FIG. 12 is a plan view illustrating an example of the surface of the separator 70 before the wound electrode bodies 20 are constructed. The separator 70 preferably further includes third formation regions 83 in addition to the first formation regions 81 and the second formation regions 82. The third formation regions 83 are closer to end portions than the first formation regions 81 in the width direction TD of the separator 70. The third formation regions 83 may be disposed at an upper end (to a U direction in FIG. 12) in the width direction TD of the separator 70 and may be disposed to a lower end (D direction in FIG. 12). As illustrated in FIG. 12, in each of the third formation regions 83, an adhesive layer 74 is formed along the longitudinal direction LD of the separator 70. The third formation regions 83 located closer to the end portion than the first formation regions 81 in the width direction TD of the separator 70 are provided in the manner described above so that the electrode and the separator 70 can be suitably bonded at the end of the wound electrode bodies 20 in the width direction TD, and thereby mixture of foreign substance and other problems can be prevented. In addition, resistance to peeling of the separator 70 and vibration resistance in use of the battery 100 can be increased. As a result, the battery 100 with higher quality can be provided.

The separator 70 preferably further includes fourth formation regions 84 in end portions where the third formation regions 83 are not formed in the width direction TD of the separator 70. The fourth formation regions 84 are regions where the adhesive layer 74 is formed along the longitudinal direction LD of the separator 70. Accordingly, the electrode and the separator 70 are more suitably bonded in end portions of the wound electrode bodies 20 in the width direction TD, and peeling of the separator 70, for example, can be prevented.

In FIG. 12, regions disposed at the upper end in the width direction TD are the third formation regions 83 and regions disposed at the lower end in the width direction TD are the fourth formation regions 84. However, this example is merely an example for convenience of description, and is not intended to limit the mode of the battery 100 disclosed here. For example, only the third formation regions 83 may be formed at the lower end in the width direction TD of the separator 70.

In the separator 70 of the battery 100 disclosed here, the weight per area of the adhesive layer 74 in the third formation regions 83 and the weight per area of the adhesive layer 74 in fourth formation regions 84 are larger than the weight per area of the adhesive layer 74 in the first formation regions 81. For example, a ratio (A/C) of the weight per area A (g/m²) of the adhesive layer 74 in the first formation regions 81 to the weight per area C (g/m²) of the adhesive layer 74 in the third formation regions 83 is preferably 0.1 or more and 0.9 or less, may be 0.2 or more and 0.75 or less, and more preferably 0.3 or more and 0.5 or less. A ratio (A/D) of the weight per area A (g/m²) of the adhesive layer 74 in the first formation regions 81 to the weight per area D (g/m²) of the adhesive layer 74 in the third formation regions 83 is preferably 0.1 or more and 0.9 or less, may be 0.2 or more and 0.75 or less, and more preferably 0.3 or more and 0.5 or less. Although not particularly limited, the weight per area of the third formation regions 83 is preferably 0.005 to 1.0 g/m² and more preferably 0.02 to 0.04 g/m². And the weight per area of the fourth formation regions 84 is preferably 0.005 to 1.0 g/m² and more preferably 0.02 to 0.04 g/m².

In a manner similar to the first formation regions 81 and the second formation regions 82 described above, the weight per area of the third formation regions 83 and the weight per area of the fourth formation regions 84 can be controlled by changing a coating pattern of the adhesive layer 74, for example. Alternatively, the weight per area of the third formation regions 83 and the weight per area of the fourth formation regions 84 can be controlled by changing the amount of coating even for the same coating pattern.

The third formation regions 83 and the fourth formation regions 84 may be intermittently provided along the longitudinal direction LD of the separator 70. It should be noted that the total length of the third formation regions 83 (fourth formation regions 84) is preferably 60% or more, and more preferably 70% or more, of the length of the separator 70 in the longitudinal direction LD. Accordingly, the effect of preventing, for example, mixture of foreign substance and the effect of vibration resistance, for example, in use of the battery 100 can be more suitably exhibited.

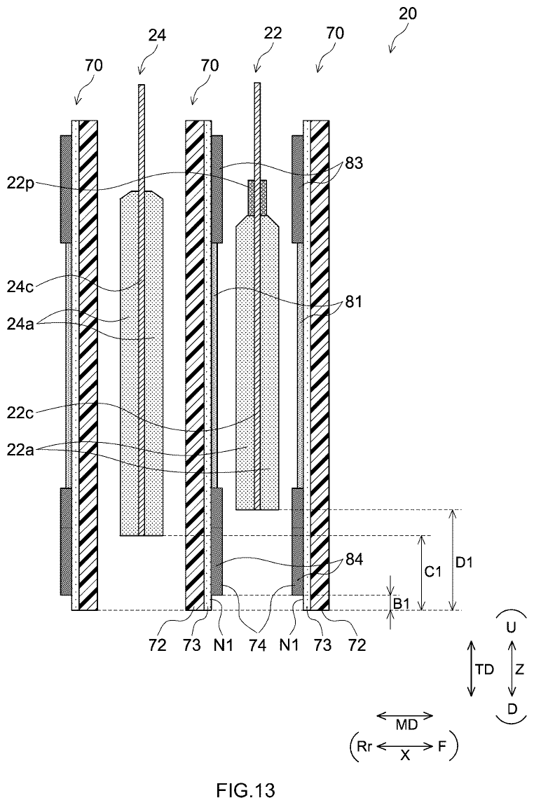

FIG. 13 is an enlarged view schematically illustrating interfaces between the separator 70 and the positive electrode 22 and the negative electrode 24 of the wound electrode bodies 20. As described above, in the separator 70 of the battery 100 disclosed here, the adhesive layer 74 is preferably disposed on at least a surface to be in contact with the positive electrode 22. In this case, in a further preferred embodiment, at least a part of the third formation regions 83 is in contact with the positive electrode active material layer 22a. Accordingly, adhesion between the positive electrode 22 and the separator 70 increases, and at least one of vibration resistance, peeling suppression of the separator 70, and prevention of mixture of foreign substance is suitably obtained.

In a case where the adhesive layer 74 is formed on at least the surface to be in contact with the positive electrode 22 in the separator 70, at least a part of the fourth formation regions 84 is preferably in contact with the positive electrode active material layer 22a. Accordingly, peeling of the separator 70 is suppressed, for example.

In a further preferred embodiment, the wound electrode bodies 20 are wound such that the adhesive layer 74 of the separator 70 and the positive electrode active material layer 22a are in contact with each other, and at least a part of the third formation regions 83 is in contact with the positive electrode active material layer 22a, and at least a part of the fourth formation regions 84 is in contact with the positive electrode active material layer 22a. Accordingly, in both end portions of the wound electrode bodies 20 in the width direction TD, the positive electrode 22 and the separator 70 are more suitably bonded, peeling of the separator 70 and mixture of foreign substance, for example, are suppressed at higher level, and thus, high-quality battery 100 can be achieved.

As described above, from the viewpoint of impregnation ability, in the separator 70, no adhesive layer 74 is preferably provided on a side to be in contact with the negative electrode 24. In this case, at least a part of the third formation regions 83 in the stacking direction MD of the wound electrode bodies 20 is preferably formed at a position overlapping with a position where the negative electrode active material layer 24a is formed. Accordingly, for example, the negative electrode 24 is not easily bent, and detachment of the negative electrode active material layer 24a from the negative electrode 24 can be reduced. In another preferred embodiment in this case, at least a part of the fourth formation regions 84 in the stacking direction MD of the wound electrode bodies 20 is preferably formed at a position overlapping with the position where the negative electrode active material layer 24a is formed.

On the other hand, in the separator 70, the adhesive layer 74 may be formed on the surface to be in contact with negative electrode 24. In this case, the wound electrode bodies 20 may be wound such that the adhesive layer 74 of the separator 70 is in contact with the negative electrode active material layer 24a and at least a part of the third formation regions 83 is in contact with the negative electrode active material layer 24a. At least a part of the fourth formation regions 84 may be in contact with the negative electrode active material layer 24a. Accordingly, adhesion between the negative electrode 24 and the separator 70 increases in end portions of the wound electrode bodies 20 in the width direction TD, and at least one of vibration resistance, peeling suppression of the separator 70, or prevention of mixture of foreign substance can be enhanced.

In the separator 70, the adhesive layer 74 does not need to be provided on a surface to be in contact with the positive electrode 22. In this case, at least a part of the third formation regions 83 in the stacking direction MD of the wound electrode bodies 20 may be formed at a position overlapping with a position where the positive electrode active material layer 22a is formed. In this case, at least a part of the fourth formation regions 84 in the stacking direction MD of the wound electrode bodies 20 may be formed at a position overlapping with a position where the positive electrode active material layer 22a is formed.

The separator 70 may include an adhesive layer non-formed region where no adhesive layer 74 is formed, in addition to the first formation regions 81, the second formation regions 82, the third formation regions 83, and the fourth formation regions 84 where the adhesive layer 74 is formed. The adhesive layer non-formed region may be provided between the first formation regions 81 and the second formation regions 82 or may be provided between the first formation regions 81, the second formation region 82, and the third formation regions 83, for example. Alternatively, the adhesive layer non-formed region may be provided between the first formation regions 81, the second formation region 82, and the fourth formation regions 84.

The adhesive layer non-formed region may be provided in both end portions of the separator 70 in the longitudinal direction LD, or may be provided on one end portion in the longitudinal direction LD. Alternatively, the adhesive layer non-formed region may be provided at one of end portions in the width direction TD, or may be provided in both end portions of the separator 70 in the width direction TD. As an example, the adhesive layer non-formed region is preferably provided in a region where a winding core used for winding the wound electrode bodies 20 and the separator 70 are in contact with each other. In other words, the adhesive layer non-formed region is preferably provided at an end of the separator 70 on the winding start side in the longitudinal direction LD. Accordingly, the constructed wound electrode bodies 20 can be easily detached from the winding core. No adhesive layer 74 is preferably formed on the outermost peripheral surface of the constructed wound electrode bodies 20. In other words, the adhesive layer non-formed region is preferably provided in an end portion of the separator 70 on the winding end side in the longitudinal direction LD. Accordingly, the wound electrode bodies 20 can be suitably housed in the electrode body holder 29, for example.

As illustrated in FIG. 13, in a bottom-side end portion (lower end portion in FIG. 13) of the separator 70, an adhesive layer non-formed region N1 where the adhesive layer 74 is not formed as described above may be provided below (on the outer outside of) the fourth formation regions 84. In this preferred embodiment, the adhesive layer non-formed region N1 is a region where the adhesive layer 74 is not formed and the heat-resistant layer 73 is exposed. Since the adhesive layer non-formed region N1 is disposed below the fourth formation regions 84, impregnating ability of the electrolyte can be enhanced, for example.

As illustrated in FIG. 13, a width from the lower end of the negative electrode active material layer 24a to the lower end of the adhesive layer non-formed region N1 of the separator 70, that is, a protrusion allowance of a bottom wall-side end portion of the separator 70 extending downward from the lower end of the opposed negative electrode active material layer 24a (toward the bottom wall-side end portion), is defined as C1. The protrusion allowance C1 is a region of the separator 70 not opposed to the negative electrode active material layer 24a. The protrusion allowance C1 is larger than a width B1 of the adhesive layer non-formed region N1 in this preferred embodiment. At this time, the width B1 of the adhesive layer non-formed region N1 and the protrusion allowance C1 preferably satisfy 0≤B1≤C1.

A width from the lower end of the opposed positive electrode active material layer 22a to the lower end of the adhesive layer non-formed region N1 is defined as D1. The width D1 is a region of the separator 70 not opposed to the positive electrode active material layer 22a. The width D1 is larger than the width B1 of the adhesive layer non-formed region N1 in this preferred embodiment. At this time, the width B1 and the width D1 preferably satisfy 0≤B1≤D1.

### Second Embodiment

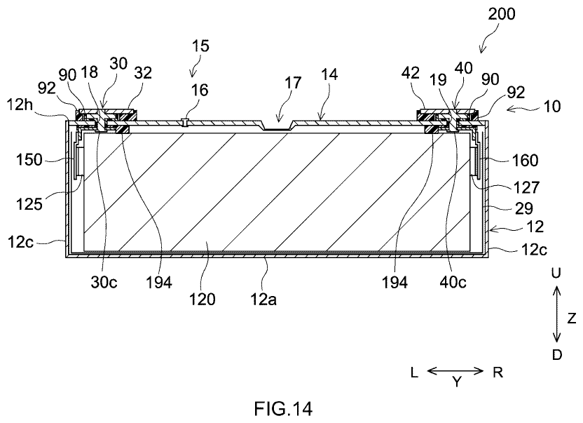

FIG. 14 illustrates a battery 200 cording to a second preferred embodiment and corresponds to FIG. 2. As illustrated in FIG. 14, the battery 200 includes wound electrode bodies 120 instead of the wound electrode bodies 20. In the battery 200, arrangement of the wound electrode bodies 120 is different from that in the first preferred embodiment. Thus, the battery 200 includes a positive electrode tab group 125 and a negative electrode tab group 127, instead of the positive electrode tab group 25 and the negative electrode tab group 27. The battery 200 includes a positive electrode current collector 150 and a negative electrode current collector 160, instead of the positive electrode current collector 50 and the negative electrode current collector 60. The battery 200 includes an internal insulating member 194, instead of the internal insulating member 94. The battery 200 may be the same as the battery 100 of the first preferred embodiment except for the components described above.

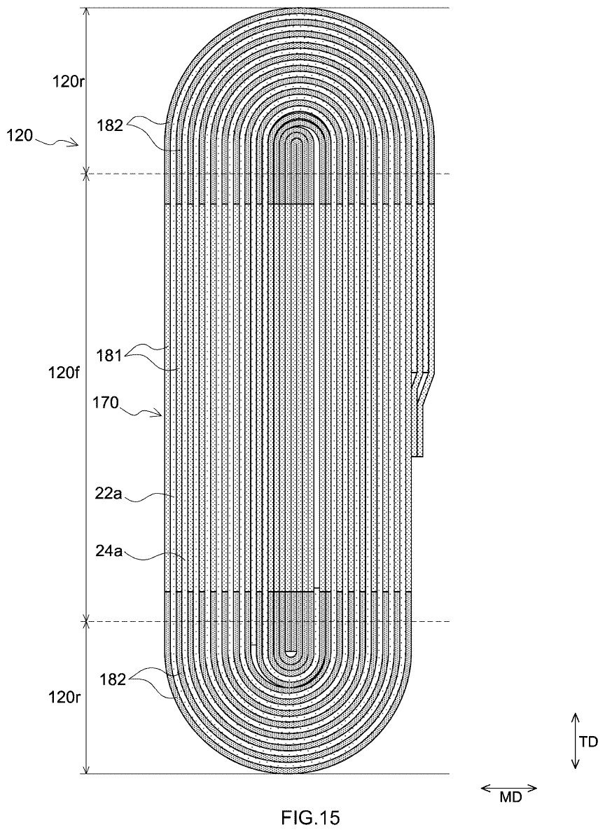

In this preferred embodiment, the wound electrode bodies 120 are housed in the battery case 10 such that a winding axis WL substantially coincides with a long-side direction Y. A pair of curved portions 120r (see FIG. 15) is opposed to a bottom wall 12a of the package 12 and the sealing plate 14. A flat portion 120f (see FIG. 15) is opposed to a long side wall of the package 12. End surfaces (i.e., stacked surfaces on which the positive electrode 22 and the negative electrode 24 are stacked) of the wound electrode bodies 120 are opposed to the pair of short side walls 12c. Materials and configurations of members constituting the wound electrode bodies 120 may be the same as those of the wound electrode bodies 20 of the first preferred embodiment.

The positive electrode tab group 125 is disposed at one end (left end in FIG. 14) of the wound electrode bodies 120 in the long-side direction Y. The negative electrode tab group 127 is disposed at the other end (right end in FIG. 14) of the wound electrode bodies 120 in the long-side direction Y. The negative electrode tab group 127 is disposed at an end opposite to the positive electrode tab group 125 in the long-side direction Y. The positive electrode current collector 150 is attached to the positive electrode tab group 125. The positive electrode tab group 125 is electrically connected to the positive electrode terminal 30 through the positive electrode current collector 150. The negative electrode current collector 160 is attached to the negative electrode tab group 127. The negative electrode tab group 127 is electrically connected to the negative electrode terminal 40 through the negative electrode current collector 160.

The internal insulating member 194 includes a projection projecting from an inner side surface of the sealing plate 14 toward the wound electrode bodies 120. In this manner, movement of the wound electrode bodies 120 in the top-bottom direction Z is restricted. Thus, even with vibrations or a shock such as drop, the wound electrode bodies 120 do not easily interfere with the sealing plate 14 so that damage of the wound electrode bodies 120 can be reduced.

FIG. 15 schematically illustrates an example of formation positions of first formation regions 181 and second formation regions 182 in the wound electrode bodies 120, and corresponds to FIG. 8. In FIG. 15, character MD indicates a direction that coincides with a short-side direction X of the battery 200, and character TD indicates a direction that coincides with a top-bottom direction Z of the battery 200. Configurations of separators 170 and 171 may be similar to those of the separators 70 and 71 of the first preferred embodiment. It should be noted that since the wound electrode bodies 120 are housed laterally in the second preferred embodiment, different characters are used to distinguish the components from those of the first preferred embodiment. Similarly, in the second preferred embodiment, it is sufficient that at least one of the separators 170 and 171 has a configuration described below.

The separator 170 includes an adhesive layer on at least a surface thereof. A weight per area (g/m²) of the adhesive layer varies in a longitudinal direction of the separator 170. The separator 170 includes, in its surface, the first formation regions 181 where the adhesive layer is formed and the second formation regions 182 where the adhesive layer is formed, and the adhesive layer in the first formation regions 181 has smaller weight per area than the adhesive layer in the second formation regions 182. In the longitudinal direction of the separator 170, the first formation regions 181 and the second formation regions 182 are repeatedly formed. In the case of housing the wound electrode bodies 120 laterally, as illustrated in FIG. 15, the pair of curved portions 120r is formed at both ends of the battery 200 in the top-bottom direction Z. At this time, in the separator 170, the first formation regions 181 are preferably disposed in the flat portion 120f, and the second formation regions 182 are preferably disposed in the curved portions 120r. Accordingly, permeability of an electrolyte in the flat portion 120f increases, an inter-pole distance in the curved portions 120r is stabilized, and battery resistance can be reduced.

The separator 170 may include third formation regions and fourth formation regions where the adhesive layer is formed, in addition to the first formation regions 181 and the second formation regions 182, in a manner similar to the first preferred embodiment. The separator 170 may include an adhesive layer non-formed region where no adhesive layer is formed.

<Application of Battery>

The battery described above can be used for various applications, and suitably used as a power source (drive power source) for a motor mounted on a vehicle such as an automobile or a truck. Although not particularly limited, examples of the type of the vehicle include a plug-in hybrid electric vehicle (PHEV), a hybrid electric vehicle (HEV), and a battery electric vehicle (BEV). Since the battery has reduced variations in battery reaction, and thus, can be suitably used for constructing a battery assembly.

Some preferred embodiments of the present disclosure have been described, but the embodiments are merely examples. The present disclosure can be carried out in other various modes. The present disclosure can be carried out based on the contents disclosed in the description and common general knowledge in the field. The techniques described in claims include various modifications and changes of the above exemplified preferred embodiments. For example, a part of the preferred embodiments described above may be replaced with another preferred embodiment, and another modified embodiment may be added to the preferred embodiments described above. It may also be deleted as appropriate if the technical features of the preferred embodiments are not described as essential.

<First Variation>

For example, in the first preferred embodiment, as illustrated in FIG. 7, the first formation regions 81 having a relatively small weight per area and the second formation regions 82 having a relatively large weight per area are repeatedly formed in the longitudinal direction LD of the separator 70. However, the first formation regions 81 and the second formation regions 82 in the separator 70 may not be repeatedly formed.

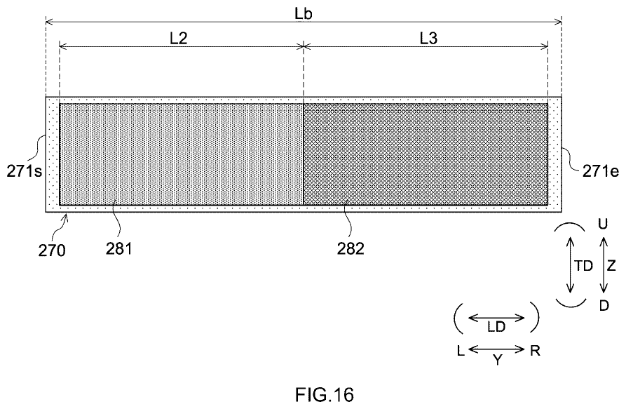

FIG. 16 is a plan view schematically illustrating a separator 270 according to a first variation. FIG. 16 illustrates the first variation and corresponds to FIG. 7. In constructing the wound electrode bodies 20, a winding start side of the separator 270 is located in a center portion of the wound electrode bodies 20 and a winding end side is located in an outer periphery portion of the wound electrode bodies 20. In the center portion of the wound electrode bodies 20, an electrolyte is not easily impregnated and impregnation ability is low as compared to an outer peripheral portion. The separator 270 of the first variation includes, in its surface, first formation regions 281 where the adhesive layer 74 is formed and second formation regions 282 where the adhesive layer 74 is formed, the adhesive layer 74 in the first formation regions 281 has smaller weight per area than the adhesive layer 74 in the second formation regions 282. And in the longitudinal direction LD of the separator 270, the first formation regions 281 are disposed on the winding start side and the second formation regions 282 are disposed on the winding end side. That is, at a center portion of the wound electrode bodies 20 having low impregnation ability, the first formation regions 281 having a relatively small weight per area are formed. Since the adhesive layer 74 is not excessively formed, the center portion of the wound electrode bodies 20 is easily impregnated with the electrolyte so that impregnation ability of the entire wound electrode bodies 20 is enhanced. In addition, since the second formation regions 282 having a relatively large weight per area are provided on the winding end side of the wound electrode bodies 20, spring back can be sufficiently reduced. Thus, both formability and impregnation ability of the wound electrode bodies 20 are achieved.

In the separator 270, the length L2 of the first formation regions 281 in the longitudinal direction LD and the length L3 of the second formation regions 282 in the longitudinal direction LD can be appropriately changed in accordance with, for example, the size of the wound electrode bodies, and thus, are not particularly limited. For example, a ratio (L2/Lb) of the length L2 of the first formation regions 281 in the longitudinal direction LD to the length Lb of the separator 270 in the longitudinal direction LD is preferably 0.1 or more and 0.9 or less, and more preferably 0.2 or more and 0.8 or less. A ratio (L3/Lb) of the length L3 of the second formation regions 282 in the longitudinal direction LD to the length Lb of the separator 270 in the longitudinal direction LD is preferably 0.1 or more and 0.9 or less, and more preferably 0.2 or more and 0.8 or less. A ratio (L2:L3) of the length L2 of the first formation regions 281 in the longitudinal direction LD to the length L3 of the second formation regions 282 in the longitudinal direction LD is preferably 10:90 to 90:10, for example, and more preferably 20:80 to 80:20.

It is sufficient that the separator 270 of the first variation is adjusted such that the weight per area the adhesive layer 74 in the first formation regions 281 is smaller than the weight per area of the adhesive layer 74 in the second formation regions 282, where regions from an end 271s on the winding start side to the center portion in the longitudinal direction LD are the first formation regions 281 and regions from an end 271e on the winding end side to the center portion in the longitudinal direction LD are the second formation regions 282. In other words, even if the first formation regions 281 include a region having a large weight per area and a region having a small weight per area and the second formation regions 282 include a region having a large weight per area and a region having a small weight per area. It is sufficient to adjust the separator 270 such that the entire first formation regions 281 has smaller weight per area than the entire second formation regions 282. For example, in the longitudinal direction LD of the separator 270, the weight per area of the adhesive layer 74 may gradually increase from the end 271s on the winding start side to the end 271e on the winding end side.

In a manner similar to the first preferred embodiment, the separator 270 may include third formation regions and fourth formation regions where the adhesive layer is formed, in addition to the first formation regions 281 and the second formation regions 282 where the adhesive layer 74 is formed. The separator 270 may include an adhesive layer non-formed region where the adhesive layer 74 is not formed.

### <Second Variation>

<Second Variation>

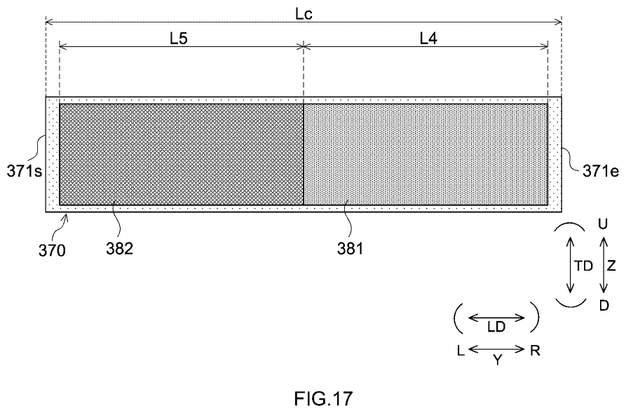

FIG. 17 is a plan view schematically illustrating a separator 370 according to a second variation. FIG. 17 illustrates the second variation and corresponds to FIG. 7. The inventors found that a gap is easily formed between the separator and the positive electrode in a center portion of the wound electrode bodies 20 and the positive electrode and the separator tend to be peeled off. The separator 370 of the second variation includes, in its surface, first formation regions 381 where the adhesive layer 74 is formed and second formation regions 382 where the adhesive layer 74 is formed, the adhesive layer 74 in the first formation regions 381 has smaller weight per area than the adhesive layer 74 in the second formation regions 382. And in the longitudinal direction LD of the separator 370, the second formation regions 382 are disposed on the winding start side and the first formation regions 381 are disposed on the winding end side. That is, in a center portion of the wound electrode bodies 20 where the positive electrode and the separator are easily peeled off, the second formation regions 382 having a relatively large weight per area are formed. Accordingly, formability of the wound electrode bodies 20 can be suitably enhanced. On the other hand, on the winding end side of the wound electrode bodies 20, the first formation regions 381 having a relatively small weight per area are formed. Accordingly, a decrease in impregnation ability can be suppressed. Thus, both formability and impregnation ability of the wound electrode bodies 20 are achieved.

In the separator 370, the length L4 of the first formation regions 381 in the longitudinal direction LD and the length L5 of the second formation regions 382 in the longitudinal direction LD can be appropriately changed in accordance with, for example, the size of the wound electrode bodies, and thus, are not particularly limited. For example, a ratio (L4/Lc) of the length L4 of the first formation regions 381 in the longitudinal direction LD to the length Lc of the separator 370 in the longitudinal direction LD is preferably 0.1 or more and 0.9 or less, and more preferably 0.2 or more and 0.8 or less. A ratio (L5/Lc) of the length L5 of the second formation regions 382 in the longitudinal direction LD to the length Lc of the separator 370 in the longitudinal direction LD is preferably 0.1 or more and 0.9 or less, and more preferably 0.2 or more and 0.8 or less. A ratio (L4:L5) of the length L4 of the first formation regions 381 in the longitudinal direction LD to the length L5 of the second formation regions 382 in the longitudinal direction LD is preferably 10:90 to 90:10, for example, and more preferably 20:80 to 80:20.

It is sufficient that the separator 370 of the second variation is adjusted such that the adhesive layer 74 in the first formation regions 381 has smaller than the weight per area of the adhesive layer 74 in the second formation regions 382, where regions from an end 371e on the winding end side to the center portion in the longitudinal direction LD are the first formation regions 381 and regions from an end 371s on the winding start side to the center portion in the longitudinal direction LD are the second formation regions 382. In other words, even if the first formation regions 381 include a region having a large weight per area and a region having a small weight per area and the second formation regions 382 include a region having a large weight per area and a region having a small weight per area, it is sufficient to adjust the separator 370 such that the entire first formation regions 381 has smaller weight per area than the entire second formation regions 382. For example, in the longitudinal direction LD of the separator 370, the weight per area of the adhesive layer 74 may gradually decrease from the end 371s on the winding start side to the end 371e on the winding end side.

In a manner similar to the first preferred embodiment, the separator 370 may include third formation regions and fourth formation regions where the adhesive layer is formed, in addition to the first formation regions 381 and the second formation regions 382 where the adhesive layer 74 is formed. The separator 370 may include an adhesive layer non-formed region where the adhesive layer 74 is not formed.

<Third Variation>

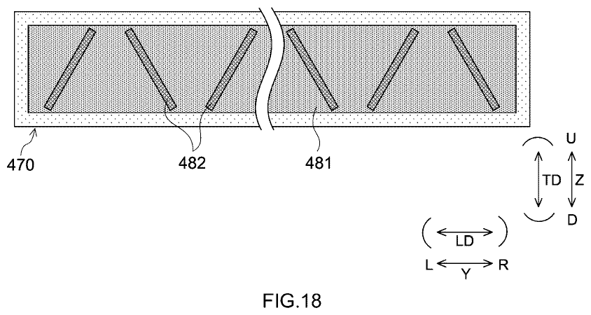

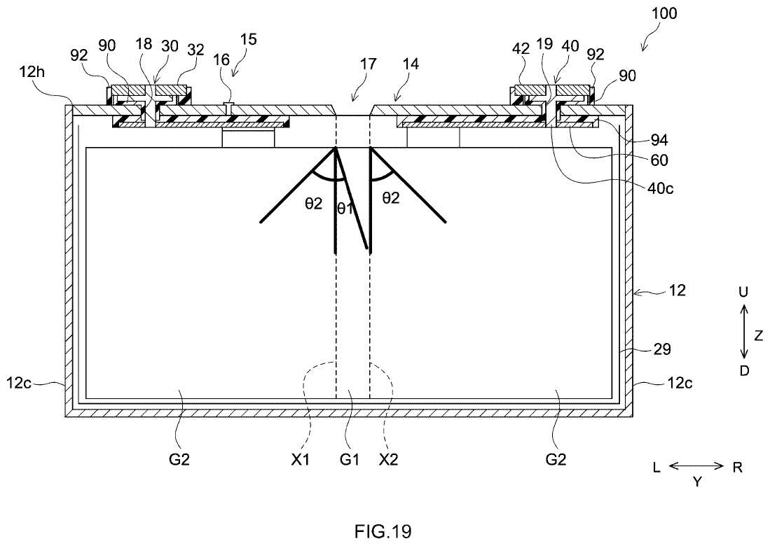

FIG. 18 is a plan view schematically illustrating a separator 470 according to a third variation. FIG. 18 illustrates the third variation and corresponds to FIG. 7. FIG. 19 is an illustration for describing a formation angle of a second formation region according to the third variation. The separator 470 of the third variation includes, in its surface, first formation regions 481 where the adhesive layer 74 is formed and second formation regions 482 where the adhesive layer 74 is formed, the adhesive layer 74 in the first formation regions 481 has smaller weight per area than the adhesive layer 74 in the second formation regions 482. And the second formation regions 482 has a pattern of stripes tilted with respect to a longitudinal direction LD of the separator 470. Accordingly, spring back can be reduced even in a state where the second formation regions 482 having a relatively large basis weight are formed in a smaller area. Thus, the first formation regions 481 having a small weight per area can be provided in a wider area so that impregnation ability is enhanced. Thus, both formability and impregnation ability of the wound electrode bodies 20 are achieved.

The second formation regions 482 may have a pattern of stripes tilted in the same direction with respect to the longitudinal direction LD of the separator 470 or may have a pattern of stripes tilted in different directions. The second formation regions 482 preferably have a pattern of stripes radially tilted from the upper end to the lower end of the separator 470 in the width direction TD, as illustrated in FIG. 18, for example. Accordingly, a gas that can be generated upon occurrence of, for example, short circuit can be suitably discharged toward the upper end. As a result, safety of the battery 100 is further enhanced.

As illustrated in FIG. 19, in the wound electrode bodies 20, a region that is defined by lines X1 and X2 vertically extending from both ends of the gas release valve 17 in the long-side direction toward the bottom wall 12a and is located immediately under the gas release valve 17 is defined as a region G1, and a region not located immediately under the gas release valve 17 is defined as a region G2. An angle of the second formation region 482 to the line X1 in the region G1 is defined as θ1, and an angle of the second formation region 482 to the line X1 (or line X2) in the region G2 is defined as θ2. At this time, the angles θ1 and θ2 of the second formation region 482 in the region G1 and the region G2, respectively, are preferably adjusted such that a gas appropriately flows toward the gas release valve 17. For example, the angle θ1 of the second formation region 482 located in the region G1 is preferably smaller than the angle θ2 of the second formation region 482 located in the region G2 (θ2>θ1). Although not particularly limited, the angle θ1 preferably satisfies 0°<θ1<90°, more preferably satisfies 0°≤θ1<45°, and may satisfy θ1=0°. Although not particularly limited, the angle θ2 preferably satisfies 0°<θ2<90°, and more preferably satisfies 0°<θ2<45°.

The adhesive layer 74 may be applied to the entire surface (solid coating) or may be applied in a predetermined pattern. For example, in the region G1 located immediately under the gas release valve 17, the adhesive layer 74 preferably has a dot pattern or a striped pattern extending in the width direction TD in plan view. In the region G2 not located immediately under the gas release valve 17, the adhesive layer 74 preferably has a striped pattern extending in the width direction TD in plan view. Accordingly, at least one of enhancement of formability of the wound electrode bodies 20, enhancement of impregnation ability, or enhancement of safety of the battery 100 can be obtained.

### <Fourth Variation>

<Fourth Variation>

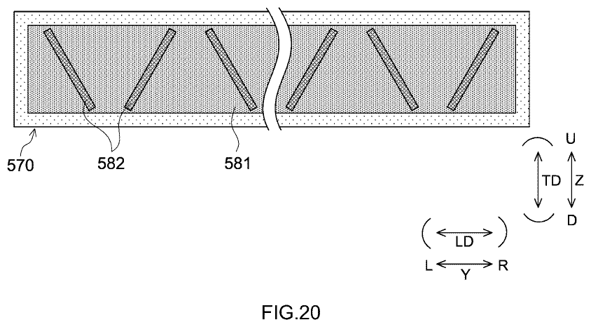

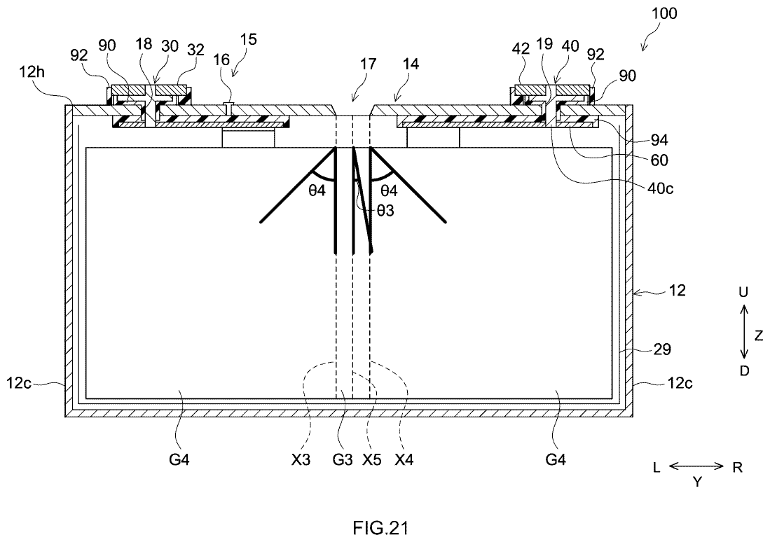

FIG. 20 is a plan view schematically illustrating a separator 570 according to a fourth variation. FIG. 20 illustrates the fourth variation and corresponds to FIG. 7. FIG. 21 is an illustration for describing a formation angle of a second formation region according to the fourth variation. The separator 570 of the fourth variation includes, in its surface, first formation regions 581 where the adhesive layer 74 is formed and second formation regions 582 where the adhesive layer 74 is formed, the adhesive layer 74 in the first formation regions 581 has smaller weight per area than the adhesive layer 74 in the second formation regions 582. And the second formation regions 582 has a pattern of stripes tilted with respect to a longitudinal direction LD of the separator 570. In a region G4 not located immediately under the gas release valve 17 of the battery 100, the second formation region 582 has a pattern of strips tilted radially from the lower end toward the upper end of the separator 570 in the width direction TD. Accordingly, impregnation ability of the wound electrode bodies 20 can be enhanced.

As illustrated in FIG. 21, in the wound electrode bodies 20, a region that is defined by lines X3 and X4 vertically extending from both ends of the gas release valve 17 in the long-side direction toward the bottom wall 12a and is located immediately under the gas release valve 17 is defined as a region G3, and a region not located immediately under the gas release valve 17 is defined as a region G4. A center line of the flat portion of the wound electrode bodies 20 in the long-side direction is defined as a line X5. An angle of the second formation region 582 to the line X5 in the region G3 is defined as θ3, and an angle of the second formation region 582 to the line X3 (or line X4) in the region G4 is defined as θ4. At this time, the angle θ3 of the second formation region 582 located in the region G3 is preferably smaller than the angle θ4 of the second formation region 582 located in the region G4 (θ4>θ3). Although not particularly limited, the angle θ3 preferably satisfies 0°≤θ3<90°, more preferably satisfies 0°≤θ3<45°, and may satisfy θ3=0°. Although not particularly limited, the angle θ4 preferably satisfies 0°<θ4<90°, and more preferably satisfies 0°<θ4<45°.

As described above, specific aspects of the technique disclosed herein include the following items:

Item 1: A battery including: a strip-shaped positive electrode including a positive electrode active material layer, a strip-shaped negative electrode including a negative electrode active material layer, a strip-shaped separator, and a wound electrode body in which the strip-shaped positive electrode and the strip-shaped negative electrode are disposed with the strip-shaped separator interposed therebetween, wherein the separator includes an adhesive layer disposed on at least a surface of the separator, the adhesive layer has a different weight per area in a longitudinal direction of the separator.
Item 2: The battery according to Item 1, wherein the separator includes first formation regions in which the adhesive layer is disposed and second formation regions in which the adhesive is disposed, the adhesive layer in the first formation regions has smaller weight per area than the adhesive layer in the second formation regions, and in the longitudinal direction of the separator, the first formation regions and the second formation regions are repeatedly disposed.
Item 3: The battery according to Item 2, wherein the wound electrode body is flat shape and includes a flat portion and a curved portion, the first formation regions are disposed in the flat portion, and the second formation regions are disposed in the curved portion.
Item 4: The battery according to Item 2 or 3, wherein at least one of a length of each of the first formation regions or a length of each of the second formation regions varies in the longitudinal direction of the separator.
Item 5: The battery according to any one of Items 2 to 4, wherein the separator includes third formation regions are disposed closer to one end of the separator than the first formation regions in a width direction orthogonal to the longitudinal direction of the separator, in the third formation regions, the adhesive layer is disposed along the longitudinal direction of the separator, and the adhesive layer in the third formation regions has larger weight per area than the adhesive layer in the first formation regions.
Item 6: The battery according to Item 5, wherein the wound electrode body is wound such that the adhesive layer and the positive electrode active material layer are in contact with each other, and at least a part of the third formation regions is in contact with the positive electrode active material layer.
Item 7: The battery according to Item 5 or 6, wherein the wound electrode body is wound such that the adhesive layer and the negative electrode active material layer are not in contact with each other, and in a stacking direction of the wound electrode body, at least a part of the third formation regions overlaps with a position where the negative electrode active material layer is disposed.
Item 8: The battery according to any one of Items 5 to 7, wherein the separator includes fourth formation regions disposed at an end where the third formation regions are not disposed, in the width direction of the separator, in the fourth formation regions, the adhesive layer is disposed along the longitudinal direction of the separator, and the adhesive layer in the fourth formation regions has larger weight per area than the adhesive layer in the first formation region.

What is claimed is:

1. A battery comprising:
a positive electrode including a positive electrode active material layer;
a negative electrode including a negative electrode active material layer;
a separator; and
a wound electrode body in which the positive electrode and the negative electrode are disposed with the separator interposed therebetween, wherein
the separator includes an adhesive layer disposed on at least a surface of the separator, and
the adhesive layer has a different weight per area in a longitudinal direction of the separator.

2. The battery according to claim 1, wherein
the separator includes first formation regions in which the adhesive layer is disposed and second formation regions in which the adhesive layer is disposed,
the adhesive layer in the first formation regions has smaller weight per area than the adhesive layer in the second formation regions, and
in the longitudinal direction of the separator, the first formation regions and the second formation regions are repeatedly disposed.

3. The battery according to claim 2, wherein
the wound electrode body is flat shape and includes a flat portion and a curved portion,
the first formation regions are disposed in the flat portion, and
the second formation regions are disposed in the curved portion.

4. The battery according to claim 2, wherein at least one of a length of each of the first formation regions or a length of each of the second formation regions varies in the longitudinal direction of the separator.

5. The battery according to claim 2, wherein
the separator includes third formation regions are disposed closer to one end of the separator than the first formation regions in a width direction orthogonal to the longitudinal direction of the separator,
in the third formation regions, the adhesive layer is disposed along the longitudinal direction of the separator, and
the adhesive layer in the third formation regions has larger weight per area than the adhesive layer in the first formation regions.

6. The battery according to claim 5, wherein
the wound electrode body is wound such that the adhesive layer and the positive electrode active material layer are in contact with each other, and
at least a part of the third formation regions is in contact with the positive electrode active material layer.

7. The battery according to claim 5, wherein
the wound electrode body is wound such that the adhesive layer and the negative electrode active material layer are not in contact with each other, and
in a stacking direction of the wound electrode body, at least a part of the third formation regions overlaps with a position where the negative electrode active material layer is disposed.

8. The battery according to claim 5, wherein
the separator includes fourth formation regions disposed at an end where the third formation regions are not disposed, in the width direction of the separator,
in the fourth formation regions, the adhesive layer is disposed along the longitudinal direction of the separator, and
the adhesive layer in the fourth formation regions has larger weight per area than the adhesive layer in the first formation region.
